(19) United States
(12) Patent Application Publication
(10) Pub. No.: US 2013/0311137 A1
(43) Pub. Date: Nov. 21, 2013

(54) TARGET DETECTION SIGNAL PROCESSOR BASED ON A LINEAR LOG LIKELIHOOD RATIO ALGORITHM USING A CONTINUUM FUSION METHODOLOGY

(71) Applicants: Brian J. Daniel, (US); Alen Schaum, (US)

(72) Inventors: ALAN SCHAUM, Alexandria, VA (US); Brian J. Daniel, Springfield, VA (US)

(73) Assignees: Brian J. Daniel, Springfield, VA (US); Alen Schaum, Alexandria, VA (US)

(21) Appl. No.: 13/895,593

(22) Filed: May 16, 2013

Related U.S. Application Data
(60) Provisional application No. 61/647,563, filed on May 16, 2012.

(51) Int. Cl. G06F 17/18

(52) U.S. Cl. CPC G06F 17/18
USPC 702/181

(57) ABSTRACT

A method including collecting physical measurement data from a sensor. The physical measurement data is converted to radiance data. The radiance data includes a plurality of radiance data points. A detection score is generated by processing the radiance data using a discriminant function. The detection score includes a plurality of detection score points corresponding to the plurality of radiance data points. The discriminant function is derived by a fusion technique using a linear log likelihood ratio principle. A detection map is generated by applying a threshold to the detection score. The detection map includes a plurality of detection map points corresponding to the plurality of radiance data points, each detection map point of the plurality of detection map points includes one of a target-indicating value and a clutter-indicating value. A presence or an absence of a target is determined from the detection map.

### CROSS-REFERENCE TO RELATED APPLICATIONS

The present application claims priority to U.S. Provisional Patent Application Ser. No. 61/647,563 filed 16 May 2012.

### FIELD OF THE INVENTION

The invention relates generally to a method of detecting a target and more particularly to a method for detecting a target contained in a spectral image, and treated as a multivariate signal.

### BACKGROUND OF THE INVENTION

Spectral imaging systems for detecting military threats, or anything with a distinctive spectral signature, are proliferating. The imaging spectrometers used to collect this data generate but one type of multivariate signal useful in target/background discrimination.

The linear matched filter (“LMF”) and the adaptive coherence estimator (“ACE”) are the industry standard target detection algorithms when a background estimate of the mean and covariance and the target signature are available.

### BRIEF SUMMARY OF THE INVENTION

An embodiment of the invention includes a method including collecting physical measurement data with a sensor. The physical measurement data is converted to radiance data. The radiance data includes a plurality of radiance data points. Each radiance data point of the plurality of radiance data points can be treated as a multi-dimensional vector. A detection score is generated by processing the radiance data using a discriminant function. The detection score includes a plurality of detection score points corresponding to the plurality of radiance data points. Each detection score point of the plurality of detection score points includes a target-likelihood value. The discriminant function is derived from a linear log likelihood ratio principle. A detection map is generated by applying a threshold to the detection score. The detection map includes a plurality of detection map points corresponding to the plurality of radiance data points, each detection map point of the plurality of detection map points includes one of a target-indicating value and a clutter-indicating value. A presence and/or an absence of a target is determined from the detection map.

Optionally, the discriminant function is represented by a curved decision surface separating at least one target from clutter. Optionally, the detection score is the value of the discriminant function, which can be described as a curved decision surface separating at least one target from clutter, for instance, on the detection map.

Optionally, generating a detection score by processing the radiance data using a discriminant function includes whitening the radiance data. Optionally, whitening the radiance data comprises whitening with global statistics, whitening with local statistics, or whitening with a local kernel's statistics.

Optionally, this method embodiment further includes providing a plurality of target signatures; and repeating for each target signature of the plurality of target signatures the generating of a detection score, the generating of a detection map, and the determining from the detection map a presence and/or an absence of a target.

An embodiment of the invention enables the extraction of difficult targets from complex backgrounds, using whatever multivariate signal is deemed most useful in discrimination. The precise nature of the signal depends on the sensing modality and the target type. Illustrative uses include detection of:
1. home-made explosives-related materials using hyperspectral imagers;
2. ocean-going vessels and spectrally distinct terrestrial objects using space-borne multispectral and other imagers;
3. poison gases using active terahertz devices;
4. biological agents using laser-induced fluorescence methods; and
5. electro-optical detection of particular shapes based on local gradient and texture information.

### BRIEF DESCRIPTION OF THE DRAWINGS

FIG. 1 is a scatter plot of whitened data including illustrative boundary curves generated by practicing an embodiment of the inventive method as well as an illustrative LMF boundary line and an illustrative ACE boundary line.

FIG. 2 is a flow chart of an embodiment of the inventive method.

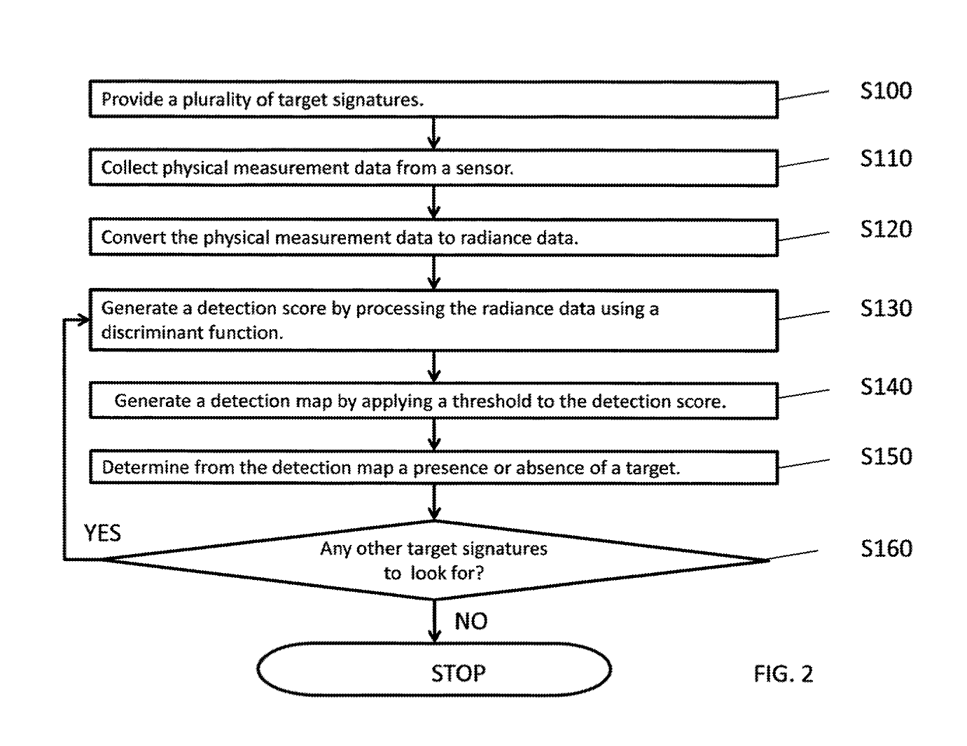

### DETAILED DESCRIPTION OF THE INVENTION

Applicants recognized that the general theoretical framework of continuum fusion (“CF”) (such as discussed in A. Schaum, Continuum Fusion, a theory of inference, with applications to hyperspectral detection, 12 Apr. 2010/Vol. 18, No. 8/OPTICS EXPRESS 8171-8188, which is incorporated herein by reference) offers a new way of looking at standard detection algorithms that many take for granted. More specifically, applicants applied a new flavor of CF, called log-linear likelihood ratio (“L³R”), to a Laplacian additive target model for hyperspectral imagery and recast the detection algorithm's dependence on free parameters into intuitive values of the asymptotic slope and vertex, as discussed below in the descriptions of various embodiments of the instant invention.

An embodiment of the method invention is described as follows. A Laplacian additive target model represents clutter by a Laplacian distribution, and the target as a mean-shifted version of the clutter. In whitened, mean-centered space and using the notation of x representing the whitened target direction and |y| representing the magnitude of all other N−1 dimensions, the log of the likelihood ratio is,

(x²+|y|²)^{1/2}−((x−t)²+|y|²)^{1/2}−k(t)=0, (1)

where k(t) is the threshold, treated here as a function of t, which is the Euclidean distance from the clutter to the target distribution mean. When applying the CF methodology to Equation (1), the form of k(t) defines the “flavor” of fusion. The flavor chosen for this application is linear, given by

k(t)=a+bt. (2)

When the parameter b is zero, the fused algorithm reduces to the standard generalized likelihood ratio test (“GLRT”). The b term produces more selective decision surfaces than GLRTs.

Using Equation (2) in Equation (1) and applying standard continuum fusion methodology produces the log-linear likelihood ratio (L³R) solution to the CF decision surface, given by

x²+|y|²)^{1/2}−|y|(1−b²)^{-1/2}=a+b(x−|y|b(1−b²)^{-1/2}). (3)

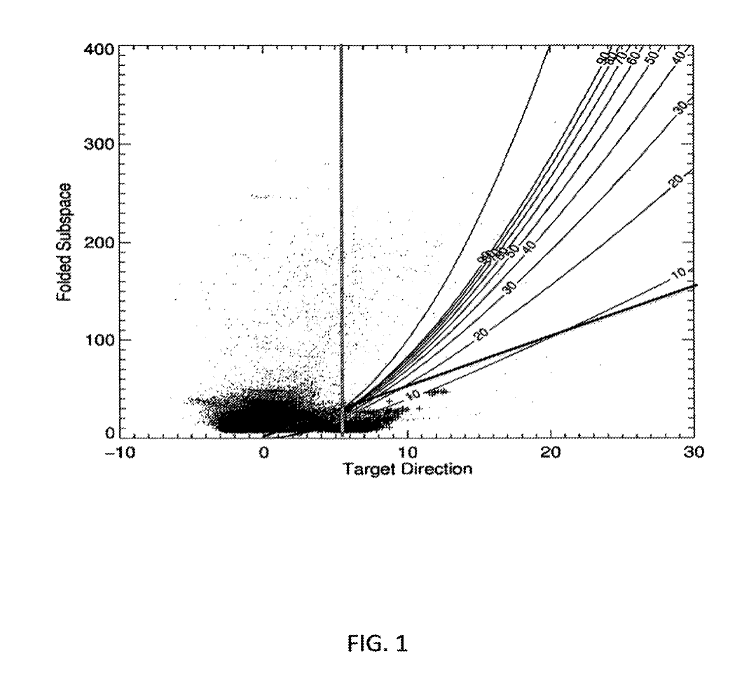

By way of illustration. FIG. 1 shows these curves defined by Equation (3) for several values of a, b, constrained to have identical x-intercepts, which we call the vertex V.

A more intuitive formulation of Equation (3) expresses it in terms of V and the asymptotic slope S, which are completely described by a and b.

$$S = \frac{\sqrt{1 - {b}^{2}}}{b} , \\ V = \frac{a}{1 - b} . \qquad ( 4 )$$

Using (4), the SV formulation of the L³R decision surface is

(x²+|y|²)^{1/2}−V=[|y|S+(x−V)](1+S²)^{-1/2} (5)

The classic formulation of detection algorithms involves comparing the detection statistic to a threshold. This form can be accomplished for Equation (5) by solving for S such that the detection score is the inverse, given as

$${S}^{- 1} = \frac{{\vert y \vert}^{2} - {( V - r )}^{2}}{\vert y \vert ( V - x ) + {( V - r ) [ {\vert y \vert}^{2} - {( V - r )}^{2} + {( V - x )}^{2} ]}^{1 / 2}} . \qquad ( 6 )$$

In an illustrative use of an embodiment of the inventive method, a typical analyst looks at the detection score of an algorithm before applying a threshold to one free parameter. L³R has two free parameters, and using a similar approach, the user will specify both. A scatter plot is used to aid in setting the vertex parameter V. Illustrated in FIG. 1, the detection surface where the slope approaches infinity for a given V defines the set of pixels where a value of the slope in Equation (8) is defined. If the target is above the V boundary, this embodiment does not detect it. The thick curved contour of FIG. 1 is the limit of L³R for the listed value of V. The user adjusts the value until satisfied. The detection score is computed as the inverse of the slope shown in Equation (8), which provides a high value for data close to the target direction. The user should use the detection score to apply the threshold on the inverse slope.

FIG. 1 displays only a small subset of the possible forms of the inventive method, corresponding to one x-intercept. In fact, the instant invention allows all nonnegative intercepts, along with an unbounded range of asymptotic slope values.

The operation of an embodiment of the inventive method, described mathematically above, can be visualized in the “folded subspace” representation of multivariate data, as shown in FIG. 1. FIG. 1 includes two decision boundaries, to illustrate the contrast in performance between an embodiment of the instant invention and two prior art detection methods. The numerically labeled curves represent decision boundaries for different L³R parameter settings according to the instant invention. Points to the right are declared “targets”, and these data show the bulk of the actual targets lying to the right of all these curves, while the true clutter points are to the left, and hence correctly labeled “clutter” by the algorithm.

The method begins with the “whitening” of the clutter data, a procedure that makes the background distribution more spherically symmetric. Whitening is a standard type of linear transformation based on the clutter covariance matrix, which is estimated from background measurements.

Another embodiment of the invention includes a method, which is described as follows with reference to FIG. 1. Physical measurement data is collected from a standard multispectral or standard hyperspectral sensor, as shown in Step S110. The physical measurement data is converted to radiance data, as shown in Step S120. The radiance data includes a plurality of radiance data points. Each radiance data point of the plurality of radiance data points is interpreted as a multi-dimensional vector. A detection score is generated by processing the radiance data using a discriminant function, as shown in Step S130. The discriminant function is derived from a linear log likelihood ratio principle. The detection score includes a plurality of detection score points corresponding to the plurality of radiance data points. Each detection score point of the plurality of detection score points includes a target-likelihood value. A detection map is generated by applying a threshold to the detection score, as shown in Step S140. The detection map includes a plurality of detection map points corresponding to the plurality of radiance data points, each detection map point of the plurality of detection map points includes a target-indicating value or a clutter-indicating value. Depending on the chosen threshold the target-likelihood value is determined to be a target-indicating value or a clutter-indicating value. A presence and/or an absence of a target is determined from the detection map, as shown in Step S150.

Optionally, the discriminant function is represented by a curved decision surface separating at least one target from clutter. Optionally, the detection score is the value of the discriminant function, which can be described as a curved decision surface separating at least one target from clutter, for instance on the detection map. For example, the presence of a target is determined by clumping of detection map points with target-indicating values to one side of the curved decision surface.

Optionally, generating a detection score by processing the radiance data using a discriminant function includes whitening the radiance data in an industry standard manner. Optionally, the whitening of the radiance data comprises whitening with global statistics in an industry standard manner, whitening with local statistics in an industry standard manner, or whitening with a local kernel's statistics in an industry standard manner.

Optionally, in this method embodiment, a plurality of target signatures is provided, as in Step S100; and for each target signature of the plurality of target signatures, the generating of a detection score, the generating of a detection map, and the determining from the detection map a presence and/or an absence of a target are repeated as indicated by Step S160.

A significant difference between L³R and other methods is its reliance on a different bulk statistical model, a multivariate spherical Laplacian. The usual model distribution is a Gaussian, which is known to give a poor match in the distribution tails, which largely determine false alarm rates.

The most significant difference from older methods is the use of the new “Continuum Fusion” methodology for producing detection algorithms. The decision boundaries for LMF are represented in FIG. 1 by a series of vertical lines (only one of which is shown) corresponding to different LMF parameter settings, analogous to the L³R curves. These declare as targets many of the clutter points (located high in the vertical folded subspace direction), which are correctly classified by L³R.

ACE is represented by a series of sloped straight lines (only one of which is shown) beginning at (0,0) and sloping up and to the right. These detectors incorrectly classify many of low-lying clutter points (in the central black blob) as targets.

Another embodiment of the instant invention requires, a background estimate of the mean and covariance and a target signature.

An embodiment of the inventive method comprises a computer program for target detection, which computer program embodies the functions, filters, or subsystems described herein. However, it should be apparent that there could be many different ways of implementing the invention in computer programming, and the invention should not be construed as limited to any one set of computer program instructions. Further, a skilled programmer would be able to write such a computer program to implement an exemplary embodiment based on the appended diagrams and associated description in the application text. Therefore, disclosure of a particular set of program code instructions is not considered necessary for an adequate understanding of how to make and use the invention. The inventive functionality of the claimed computer program will be explained in more detail in the following description read in conjunction with the figures illustrating the program flow.

One of ordinary skill in the art will recognize that the methods, systems, and control laws discussed above with respect to target detection may be implemented in software as software modules or instructions, in hardware (e.g., a standard field-programmable gate array (“FPGA”) or a standard application-specific integrated circuit (“ASIC”), or in a combination of software and hardware. The methods, systems, and control laws described herein may be implemented on many different types of processing devices by program code comprising program instructions that are executable by one or more processors. The software program instructions may include source code, object code, machine code, or any other stored data that is operable to cause a processing system to perform methods described herein.

The methods, systems, and control laws may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions and/or data structures described herein may be connected directly or indirectly to each other in order to allow the flow of data needed for their operations. It is also noted that software instructions or a module can be implemented for example as a subroutine unit or code, or as a software function unit of code, or as an object (as in an object-oriented paradigm), or as an applet, or in a computer script language, or as another type of computer code or firmware. The software components and/or functionality may be located on a single device or distributed across multiple devices depending upon the situation at hand.

Systems and methods disclosed herein may use data signals conveyed using networks (e.g., local area network, wide area network, internet, etc.), fiber optic medium, carrier waves, wireless networks, etc. for communication with one or more data processing devices. The data signals can carry any or all of the data disclosed herein that is provided to or from a device.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

These and other implementations are within the scope of the following claims.

What is claimed as new and desired to be protected by Letters Patent of the United States is:

1. A method comprising:
collecting physical measurement data from a sensor;
converting the physical measurement data to radiance data, the radiance data comprising a plurality of radiance data points, each radiance data point of the plurality of radiance data points comprising a multi-dimensional vector;
generating a detection score by processing the radiance data using a discriminant function, the detection score comprising a plurality of detection score points corresponding to the plurality of radiance data points, each detection score point of the plurality of detection score points comprising a target-likelihood value, the discriminant function derived from a linear log likelihood ratio principle;
generating a detection map by applying a threshold to the detection score, the detection map comprising a plurality of detection map points corresponding to the plurality of radiance data points, each detection map point comprising one of a target-indicating value and a clutter-indicating value; and
determining from the detection map one of a presence and an absence of a target.

2. The method according to claim 1, wherein the discriminant function is represented by a curved decision surface separating at least one target from clutter.

3. The method according to claim 1, wherein said generating a detection score by processing the radiance data using a discriminant function comprises whitening the radiance data.

4. The method according to claim 3, wherein said whitening the radiance data comprises one of whitening with global statistics, whitening with local statistics, and whitening with a local kernel's statistics.

5. The method according to claim 1, further comprising:
providing a plurality of target signatures; and
repeating for each target signature of the plurality of target signatures said generating a detection score, said generating a detection map, and said determining from the detection map at least one of a presence and an absence of a target.

6. A method of target detection, wherein physical measurement data is collected from a sensor and converted to radiance data, the radiance data comprising a plurality of radiance data points, each radiance data point of the plurality of radiance data points comprising a multi-dimensional vector, the method comprising:
generating a detection score by processing the radiance data using a discriminant function, the detection score comprising a plurality of detection score points corresponding to the plurality of radiance data points, each detection score point of the plurality of detection score points comprising a target-likelihood value, the discriminant function derived from a linear log likelihood ratio principle;
generating a detection map by applying a threshold to the detection score, the detection map comprising a plurality of detection map points corresponding to the plurality of radiance data points, each detection map point comprising one of a target-indicating value and a clutter-indicating value; and
determining from the detection map one of a presence and an absence of a target.

7. The method according to claim 6, wherein the discriminant function is represented by a curved decision surface separating at least one target from clutter.

8. The method according to claim 6, wherein said generating a detection score by processing the radiance data using a discriminant function comprises whitening the radiance data.

9. The method according to claim 8, wherein said whitening the radiance data comprises one of whitening with global statistics, whitening with local statistics, and whitening with a local kernel's statistics.

10. The method according to claim 6, further comprising:
providing a plurality of target signatures; and
repeating for each target signature of the plurality of target signatures said generating a detection score, said generating a detection map, and said determining from the detection map at least one of a presence and an absence of a target.
